(19) United States
(12) Patent Application Publication
(10) Pub. No.: US 2017/0051879 A1
(43) Pub. Date: Feb. 23, 2017

(54) LED Light

(71) Applicant: Modern Home Lighting Inc., Dongguan City (CN)

(72) Inventor: Sheng-Chi Chung, Dongguan City (CN)

(21) Appl. No.: 15/193,160

(22) Filed: Jun. 27, 2016

(30) Foreign Application Priority Data
Aug. 17, 2015 (CN) 201510504252.2

(51) Int. Cl. H01K 1/62; F21V 19/00; F21V 23/00

(52) U.S. Cl. CPC F21K 9/238; F21K 9/235; F21V 19/006; F21V 23/002

(57) ABSTRACT

An LED light contains: a connector and a base. The connector includes an integrated circuit (IC) chip mounted therein, a threaded extension extending outwardly from a bottom of the connector, and a transparent disc fixed on a top of the connector. The base includes a threaded orifice defined thereon so as to screw with the threaded extension of the connector. In addition, the IC chip has a plurality of LED elements arranged thereon and has an electronic wire connected therewith.

### FIELD OF THE INVENTION

The present invention relates to an LED light which avoids replacement of the IC chip and using a voltage transformer so as to save using and replacement costs.

### BACKGROUND OF THE INVENTION

A conventional lamp is connected with a lamp holder configured to mount various LED lights, and the lamp holder contains a voltage transformer accommodated therein so as to convert voltage and to drive an LED light to illuminate lights, thus increasing production cost of the voltage transformer.

To overcome above-mentioned problem, an improved LED light has been developed. The improved LED light includes an integrated circuit which is connected with a voltage transformer so that the integrated circuit transforms voltage and provides constant currents to the LED light. However, it is inconvenient to replace the integrated circuit, after the integrated circuit is broken.

The present invention has arisen to mitigate and/or obviate the afore-described disadvantages.

### SUMMARY OF THE INVENTION

The primary objective of the present invention is to provide an LED light which avoids replacement of the IC chip and using a voltage transformer so as to save using and replacement costs.

To obtain above-mentioned objective, an LED light provided by the present invention contains: a connector and a base.

The connector includes an integrated circuit (IC) chip mounted therein, a threaded extension extending outwardly from a bottom of the connector, and a transparent disc fixed on a top of the connector. The base includes a threaded orifice defined thereon so as to screw with the threaded extension of the connector. In addition, the IC chip has a plurality of LED elements arranged thereon and has an electronic wire connected therewith.

Accordingly, when the IC chip is broken, the connector is replaced so as to avoid replacement of the IC chip and using the voltage transformer.

### BRIEF DESCRIPTION OF THE DRAWINGS

FIG. 1 is a perspective view showing the assembly of an LED light according to a preferred embodiment of the present invention.

FIG. 2 is a perspective view showing the exploded components of the LED light according to the preferred embodiment of the present invention.

FIG. 3 is a cross sectional view showing the exploded components of the LED light according to the preferred embodiment of the present invention.

FIG. 4 is a cross sectional view showing the assembly of the LED light according to the preferred embodiment of the present invention.

### DETAILED DESCRIPTION OF THE PREFERRED EMBODIMENTS

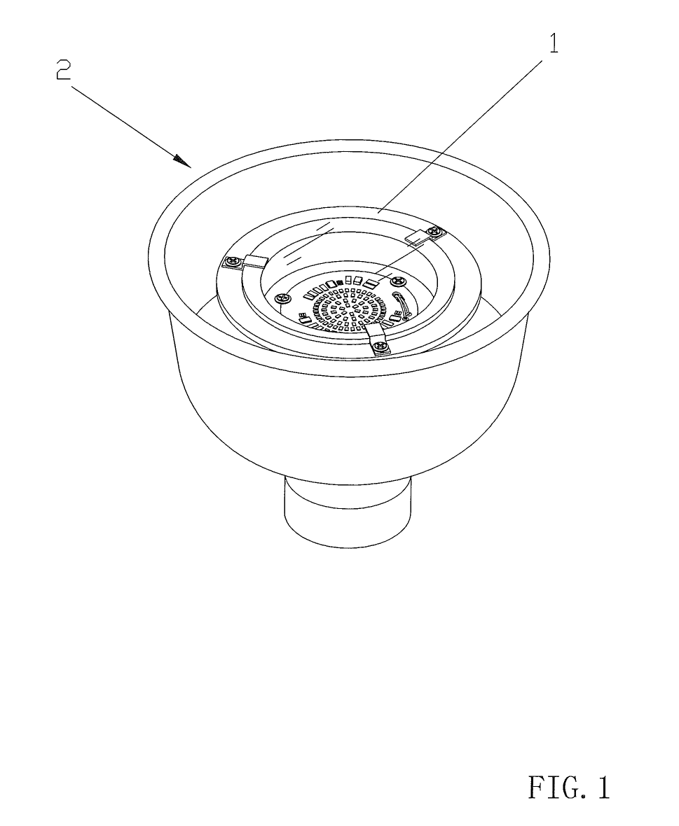

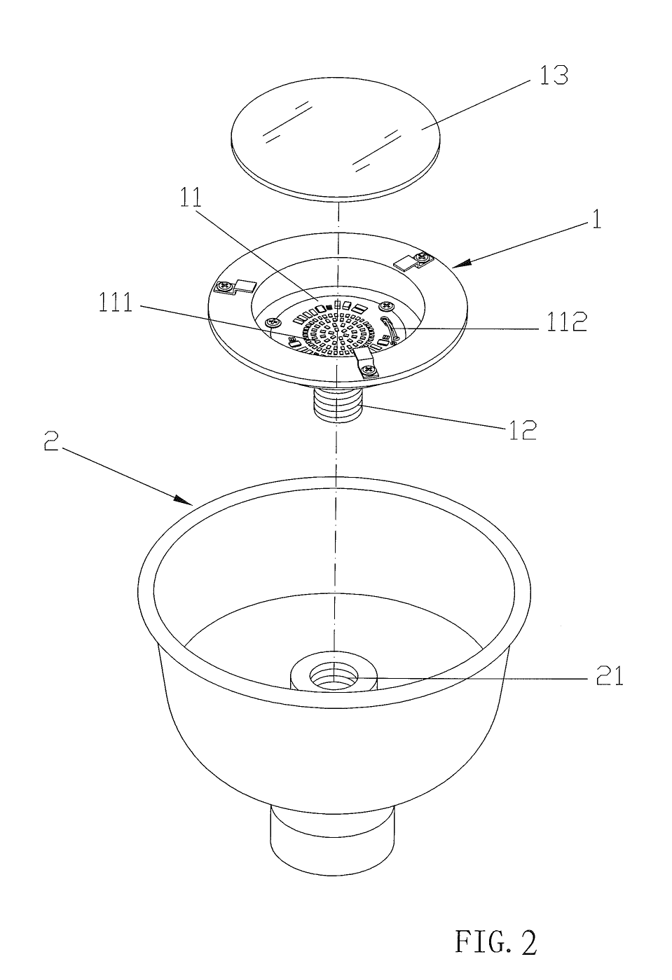

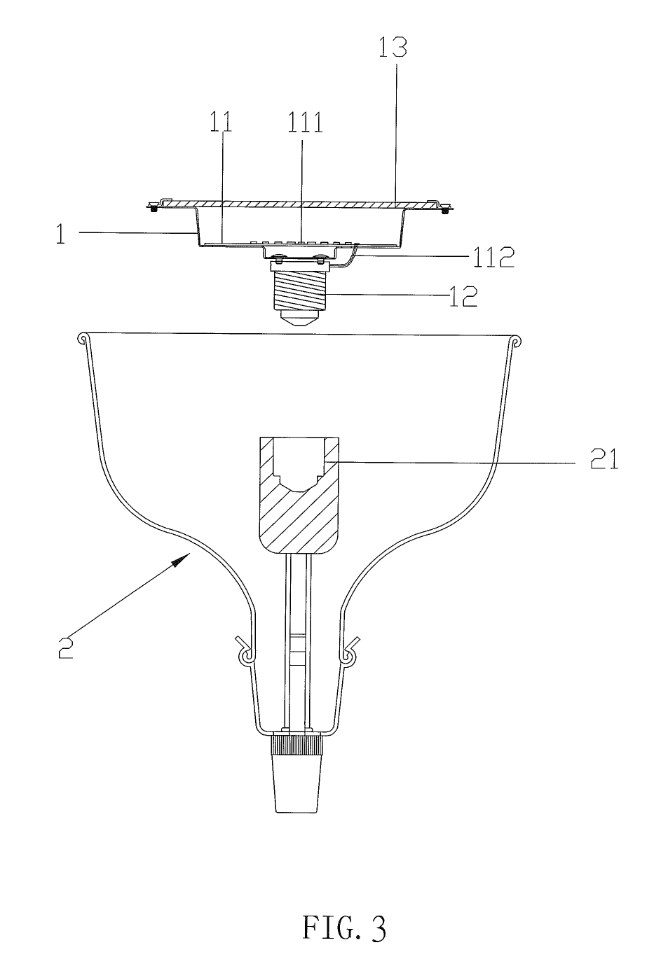

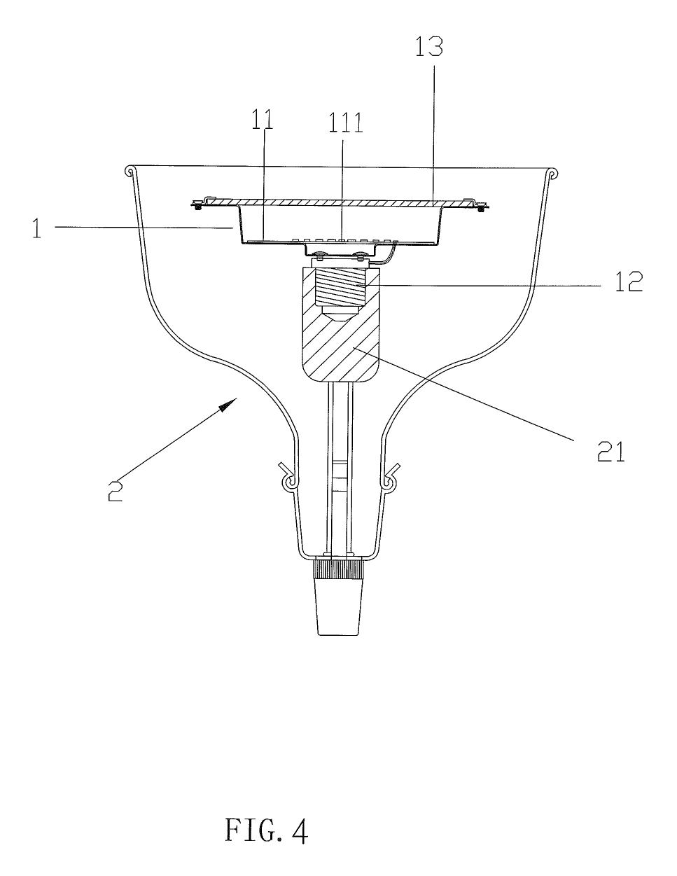

Referring to FIGS. 1 to 4, an LED light according to a preferred embodiment of the present invention is connected with a lamp holder configured to mount various LED lights, and the LED light comprises:

a connector 1 in which an integrated circuit (IC) chip 11 is mounted, a threaded extension 12 extending outwardly from a bottom of the connector 1, and a transparent disc 13 fixed on a top of the connector 1; wherein the IC chip 11 has a plurality of LED elements 111 arranged thereon, and the IC chip 11 has an electronic wire 112 connected therewith;

a base 2 on which a threaded orifice 21 is defined so as to screw with the threaded extension 12 of the connector 1.

In assembly, the IC chip 11 is mounted in the connector 1, and the connector 1 is in connection with the base 2 by screwing the threaded extension 12 with the threaded orifice 21, hence the IC chip 11 drives the plurality of LED elements 111 to illuminate lights after transforming voltage.

Preferably, when the IC chip 11 is broken, the connector 1 is replaced so as to avoid replacement of the IC chip 11 and using a voltage transformer.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. An LED light comprising:
a connector in which an integrated circuit (IC) chip is mounted, a threaded extension extending outwardly from a bottom of the connector, and a transparent disc fixed on a top of the connector; and
a base on which a threaded orifice is defined so as to screw with the threaded extension of the connector;
wherein the IC chip has a plurality of LED elements arranged thereon, and the IC chip 11 has an electronic wire connected therewith.
